(19) United States
(12) Patent Application Publication
(10) Pub. No.: US 2024/0008537 A1
(43) Pub. Date: Jan. 11, 2024

(54) Heater Device Component

(71) Applicant: JT International SA, Geneva (CH)

(72) Inventors: Alec Wright, Guildford (GB); Andrew Robert John Rogan, Forres (GB); Olayiwola Olamiposi Popoola, Walton-on-Thames (GB); Kyle Adair, Lisburn (GB); Gordon Montgomery, Ballymena (GB)

(73) Assignee: JT International SA, Geneva (CH)

(21) Appl. No.: 18/018,718

(22) PCT Filed: Jul. 27, 2021
(86) PCT No.: PCT/EP2021/071040

§ 371 Date: Jan. 30, 2023

(30) Foreign Application Priority Data
Jul. 29, 2020 (EP) 20188459.0

(51) Int. Cl. A24F 40/46; H05B 3/06; A24F 40/10; A24F 40/48

(52) U.S. Cl. CPC A24F 40/46; H05B 3/06; A24F 40/10; A24F 40/48; H05B 2203/021

(57) ABSTRACT

A heater device for an electronic cigarette includes: a heater unit arranged to vaporise a liquid received from a liquid reservoir to generate a vapour; and a vapour flow path extending from the heater unit arranged to fluidly communicate with a mouthpiece of an electronic cigarette to allow the generated vapour to flow from the heater unit to the mouthpiece. The heater unit includes a first heating portion and a second heating portion, and the first and second heating portions are integrally formed such that the first and second heating portions form a single heater unit.

### FIELD OF INVENTION

The present invention relates to vapour generation devices, and more specifically heaters for vapour generation devices.

### BACKGROUND

Vapour generating devices, such as electronic cigarettes, are becoming increasingly popular consumer products.

Heating devices for vaporisation or aerosolisation are known in the art. Such devices typically include a heater arranged to heat a vaporisable product. In operation, the vaporisable product is heated with the heater to vaporise the constituents of the product for the consumer to inhale. In some examples, the product may comprise tobacco in a capsule or may be similar to a traditional cigarette, in other examples the product may be a liquid, or liquid contents in a capsule.

There is a need to improve the experience of the consumer of such products; an object of the present invention is to address this need by improving the quality of the vapour flow. There is also a need to improve heater operation; another object of the invention is to address this.

### SUMMARY

According to a first aspect there is provided a heater device for an electronic cigarette comprising a heater unit arranged to vaporise a liquid received from a liquid reservoir to generate a vapour. A vapour flow path extends from the heater unit arranged to fluidly communicate with a mouthpiece of an electronic cigarette to allow the generated vapour to flow from the heater unit to the mouthpiece. The heater unit comprises a first heating portion and a second heating portion. The first and second heating portions are integrally formed such that the first and second heating portions form a single heater unit.

By combining the first and second heating portions into a single heater unit, the overall number of components in the heater device is reduced. This reduces manufacturing costs and assembly of the heater device is simplified. Further, providing a single heater unit, rather than two separate heating portions, improves the heating efficiency of the heater device, which may reduce the amount of energy required to be supplied to the heater device.

Preferably, first heating portion is arranged to heat liquid received from a liquid reservoir of an electronic cigarette to generate a vapour.

The second heating portion is preferably arranged to heat the vapour generated by the first heating portion. The vapour generated by the first heating portion is therefore reheated by the second heating portion. Since the initially generated vapour is typically a cold vapour, there is a risk of the vapour condensing within the heater device before it can be inhaled by the user. Condensed vapour with the heater device increase the risk of leaks and short circuits within the heater device, which is dangerous. By reheating the vapour, the risk of the vapour condensing before it reaches the user is reduced. Thus the chance of leakage and short circuits with the heater device is also reduced. Additionally, reheating the vapour helps control the size of the droplets within the generated vapour, in particular the size of the droplets will be more consistent throughout the vapour. Thus, reheating the generated vapour leads to improved droplet size distribution which helps provide a more homogenous vapour to the user.

The first heating portion may comprise a first surface and a second surface. The first and second surfaces may be spaced a part from each other. Separating the first and second surfaces provides sufficient space for a vapour to be generated.

The first surface is preferably arranged to allow fluid communication between a liquid reservoir of an electronic cigarette and the heater unit. This allows fluid to flow from the reservoir into the heater unit.

The second surface is preferably arranged to allow fluid communication between the heater unit and a mouthpiece of the electronic cigarette via the vapour flow path. This allows fluid, in particular vapour, to flow from the heater unit into the vapour flow path and to the mouthpiece.

The heater unit may comprises a filter arranged to filter the generated vapour as it flows from the heater unit to the vapour flow path. This may provide a more consistent vapour to be inhaled by the user, which may improve the mouthfeel of the vapour and the overall user experience when using the heater device.

In some cases, the filter may comprise a plurality of through-channels. The through-channels may be arranged to pass through the second surface. The second surface may therefore be considered to form part of the filter. The first and second surfaces may be spaced apart from each other by the through-channels.

In some examples, the diameter of all the through-channels in the plurality of through-channels may be substantially the same. This may ensure that the vapour droplets which pass through the filter are all the same size, providing a more consistent vapour for the user to inhale. In other examples, the diameter of all the through-channels in the plurality of through-channels may be different. This may allow vapour droplets having different sizes to pass through the filter. This may be allow different types of aerosol generating liquid to be used, which may produce vapours having different sized droplets.

Preferably, the second heating portion is arranged to prevent fluid communication between a reservoir of an electronic cigarette and the vaporising chamber. This may ensure that vapour is only generated by the first heating portion. More preferably, the second heating portion may be arranged to prevent fluid communication between the reservoir and the vapour flow path. This prevents generated vapour from re-entering the reservoir.

The second heating portion is located substantially next to the first heating portion. In particular, at least part of the second heating portion extends substantially next to at least part of the first heating portion. This may provide a compact heater unit.

In some examples, the second heating portion extends laterally alongside the first heating portion. In other examples, second heating portion is arranged substantially peripherically around the first heating portion.

The vapour flow path may comprise a first vapour flow path and a second vapour flow path. The generated vapour may be arranged to flow away from a mouthpiece along the first vapour flow path and towards a mouthpiece along the second vapour flow path. The generated vapour is therefore redirected as it flows along the vapour flow path between the heater unit and the mouthpiece.

Preferably the second heating portion is located within the second vapour flow path. This ensures that the second heating portion is able to heat the generated vapour before it reaches the mouthpiece.

The heater device may comprise an airflow path extending between an air inlet and the heater unit. This allows air to enter into the heater unit.

Preferably, the generated vapour is delivered to the second heating portion from the first heating portion under the action of air which has entered the air inlet and flowed along the airflow path. The air flowing into the heater device therefore acts to redirect the generated vapour from the first heating portion to the second heating portion. This ensures that the generated vapour is re-heated by the second heating portion before it reaches the mouthpiece. Using the action of air flowing into the heater device to redirect the generated vapour provides a simple mechanism for redirecting the generated vapour, without the need for additional components. Thus reduces the complexity of the overall heater device, making it cheaper to manufacture.

According to a second aspect there is provided a capsule for an electronic cigarette, the capsule having a first end configured to engage with an electronic cigarette device and a second end arranged as a mouthpiece portion having a vapour outlet. The capsule further comprises a reservoir arranged to store a liquid to be vaporised, and a heater unit arranged to vaporise liquid received from the reservoir to generate a vapour. A vapour flow path extends between the heater unit and the mouthpiece to allow the generated vapour to flow from the heater unit to the mouthpiece. The heater unit comprises a first heating portion and a second heating portion. The first and second heating portions are integrally formed such that the first and second heating portions form a single heater unit.

There may be provided a capsule for use with a vapour generating device, the capsule comprising the heater device, and any of its modifications, as described herein. In this way, the heater device can form part of a consumable capsule and can be replaceable in a vapour generation device. In particular, this can be beneficial when changing to a vaporisable substance of a different flavour, in a new capsule, as a new heater unit would be used and the generated vapour would not be contaminated with residual flavouring from the previous vaporisable substance.

According to a third aspect there is provided an electronic cigarette comprising a main body and a capsule wherein the main body comprises a power supply unit, electrical circuitry, and a capsule seating configured to connect with the capsule. The capsule comprises a first end configured to engage with the electronic cigarette device and a second end arranged as a mouthpiece portion having a vapour outlet. The capsule further comprises a reservoir arranged to store a liquid to be vaporised, and a heater unit arranged to vaporise liquid received from the reservoir to generate a vapour. A vapour flow path extends between the heater unit and the mouthpiece to allow the generated vapour to flow from the heater unit to the mouthpiece. The heater unit comprises a first heating portion and a second heating portion. The first and second heating portions are integrally formed such that the first and second heating portions form a single heater unit.

There may be provided a vapour generating device comprising the heater device, and any of its modifications, as described herein.

### BRIEF DESCRIPTION OF DRAWINGS

Embodiments of the invention are now described, by way of example, with reference to the drawings, in which:

FIG. 1 is a conceptual cross-sectional view of a portion of a vaporisation component for a vapour generation device;

FIG. 2 is a conceptual cross-sectional view of a vaporisation component integrated into a portion of a vapour generation device;

FIG. 3 is a perspective view of a vaporisation component for a vapour generation device; and

FIG. 4 is a perspective view of a vaporisation component for a vapour generation device.

### DETAILED DESCRIPTION

A vapour generation device is a device arranged to heat a vapour generating product to produce a vapour for inhalation by a consumer. In a specific example, a vapour generating product can be a liquid which forms a vapour when heated by the vapour generation device. A vapour generation device can also be referred to as an electronic cigarette or aerosol generation device. In the context of the present disclosure, the terms vapour and aerosol can be used interchangeably. A vapour generating product, or aerosol generating product, can be a liquid or a solid such as a fibrous material, or a combination thereof, that when heated generates a vapour or aerosol.

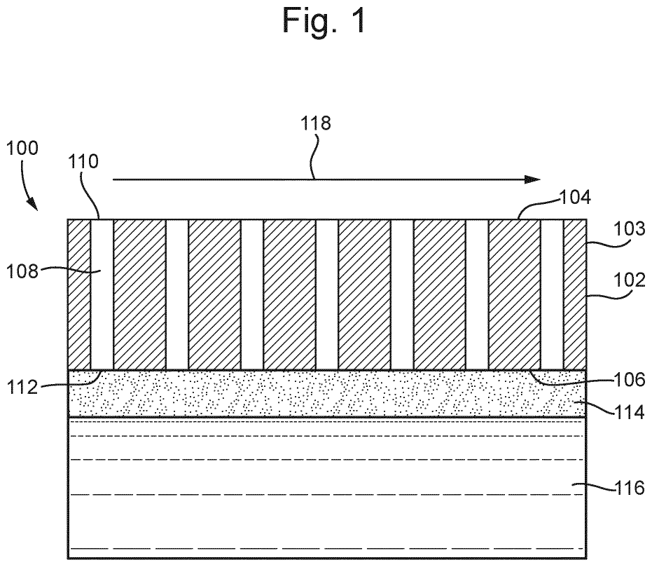

FIG. 1 shows a cross-sectional diagram of a portion of a vaporisation component 100 for a vapour generation device. In this case, the vaporisation component 100 is a heater device 100.

The vaporisation component 100 comprises an evaporator component 102, arranged to vaporise a liquid received from a liquid reservoir in order to generate a vapour, and a vapour flow path 128 extending from the evaporator component 102 arranged to fluidly communicate with a mouthpiece of the vapour generation device to allow the generated vapour to flow from the evaporator component 102 to the mouthpiece. The evaporator component 102 may also be referred to as a heater unit 102.

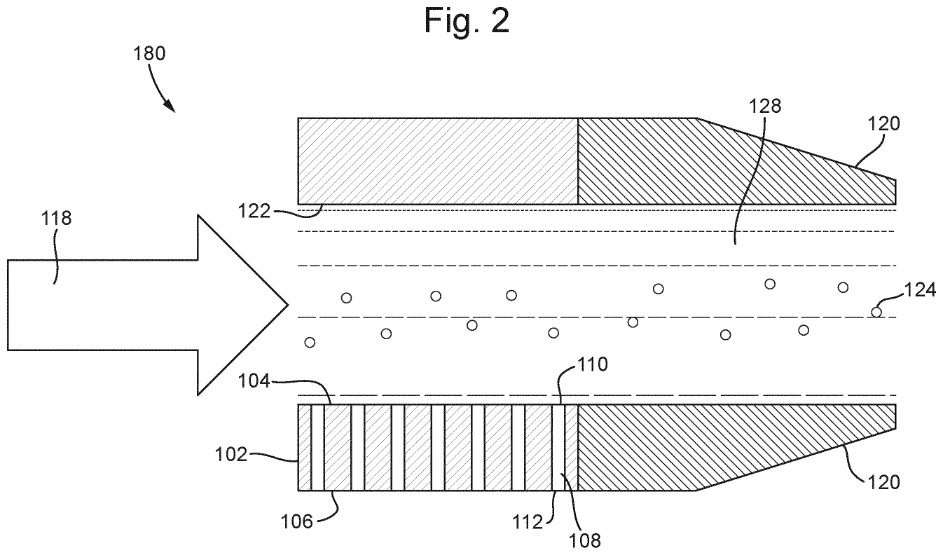

The heater device 100 is in fluid communication with a reservoir 116 which is arranged to store a liquid vapour generating product. The evaporator component 102 (hereinafter referred to as the heater unit) can be considered as an evaporator block or heater, and in an example can be formed from silicon. FIG. 2 shows a conceptual cross-sectional diagram of the heater unit 102 integrated into a portion 180 of a vapour generation device.

The heater unit 102 has a first heating portion 103 comprising a first surface 106 and a second surface 104. The first and second surfaces 106, 104 are spaced apart from each other.

The second surface 104 faces toward the vapour flow path 128 of the vapour generation device. The second surface 104 therefore provides fluid communication between the heater unit 102 and the mouthpiece via the vapour flow path 128, which allows vapour to flow from the heater unit 102 into the vapour flow path 128 and to the mouthpiece. The vapour flow path 128, which may also be referred to as an airflow channel 128 of the vapour generation device, is a channel through which air flows substantially in a direction 118 towards the mouthpiece 120 when a consumer draws upon the mouthpiece 120. In other words, the airflow channel 128 connects air inlets (not shown) within the vapour generation device to the mouthpiece 120 for the passage of air through the vapour generation device. The airflow channel 128 is arranged to transport generated vapour to the mouthpiece 120 through which the vapour is inhaled by a user. The second surface 104 of the heater unit 102 can be arranged in the airflow channel 128, and in the example of FIGS. 1 and 2 can form a portion of an internal sidewall of the airflow channel 128. The cross-section of FIGS. 1 and 2 are viewed along a direction perpendicular to the direction along the airflow channel 128 toward the mouthpiece 120.

In an example, the heater unit 102 can be a micro-electro-mechanical system (MEMS) evaporator, this evaporator can be silicon-based at least in part.

The first surface 106 is on a separate face to the second surface 104. In the example of FIGS. 1 and 2 the first surface 106 is spaced apart from the second surface 104, on an opposing face to the second surface 104. The first surface 106 of the heater unit 102 is arranged to be in fluid communication with the reservoir 116. This means that the first surface 106 allow fluid communication between the reservoir 116 and the heater unit 102 allowing fluid to flow from the reservoir into the heater unit 102.

A plurality of channels 108 are arranged through the heater unit 102 to connect a set of first openings 110 in the second surface 104 to a corresponding set of second openings 112 in the first surface 106. That is, each of these channels 108 is a through-hole that passes through the heater unit 102, and so the channels 108 may also be referred to as through-channels 108. The through-channels 108 are arranged such that one end of each through-channel 108 forms a first opening 110 in the second surface 104 and the other end of each through-channel 108 forms a second opening 112 in the first surface 106. These through-channels 108 can be in an array type arrangement and are of micrometre scale.

The through-channels 108 are arranged to draw liquid from the reservoir 116 through the second openings 112, through the through-channels 108, and to the first openings 110 by capillary force.

Any suitable number of through-channels 108, with corresponding numbers of first 110 and second openings 112, can be arranged in the heat unit 102. In some examples there may be one through-channel 108. Alternatively, there may be a plurality of through-channels 108. In this case, the diameter of all the through-channels 108 in the plurality of through-channels is substantially the same. However, in other examples, the diameter at least one of the through-channels 108 in the plurality of through-channels 108 may be different from the diameter of the other through-channels 108.

The through-channels 108 provide a filtering function, acting to filter the generated vapour as it flows from the heater unit 102 into the airflow channel 128. This is because a particular channel size or diameter can selectively pass liquids with different fluid properties from the reservoir through the heater unit 102 via the through-channels 108, for example due to different surface tensions of these liquids.

The through-channels 108 pass through the second surface 104 and so the second surface 104 may be considered as comprising a filter, which filters the generated vapour as it flows from the through-channels 108 to the vapour flow path 128.

In some examples, an optional wicking material 114 can be incorporated into the vaporisation component 100, and in particular can be arranged between the first surface 106 of the heater unit 102 and the reservoir 116. The wicking material 114 can aid in the transfer of liquid from the reservoir 116 to the second openings 112 in the first surface 106. In this way, the reservoir 116 can either be in direct connection with the first surface 106 of the heater unit 102, or in indirect connection with the first surface 106 by way of the wicking material 114.

For clarity, only the heater unit 102 of the vaporisation component 100 is shown in FIG. 2; the reservoir 116 and optional wicking material 114 are not shown but can readily be included.

Generally in operation, liquid is drawn from the reservoir 116 into the second openings 112 in the first surface 106 of the heater unit 102. The liquid then travels into and through the through-channels 108 by capillary action. A potential is applied to the heater unit 102 by a heater control circuit (not shown) so as to heat the heater unit 102. In turn the heater unit 102 heats the liquid through the sidewalls of the through-channels 108, as the liquid is drawn through the through-channels 108, to create a vapour. The side walls of the through-channels 108 can be considered as forming at least part of the first surface 106 being configured to release the generated vapour into the through-channels 108. The through-channels 108 therefore act like a vapour chamber for collecting the generated vapour from the first surface 106 of the heater unit 102, which in this case is the sidewalls of the through-channels 108. The vapour then exits the through-channels 108 as a vapour flow through the first openings 110 in the second surface 104 and enters the airflow channel 128 of the vapour generation device. This vapour flow can also include liquid droplets 124 from the through-channels 108. The through-channels 108 therefore allow the generated vapour to flow from the heater unit 102 to the airflow channel 128, and so the through-channels 108 can be considered to form part of the airflow channel 128.

In the example of FIG. 2, the second surface 104 of the heater unit 102 partially defines an internal wall of the airflow channel 128. The airflow channel 128 can be considered as a tube or passageway, defined by internal walls, through which the air and vapour travels to the mouthpiece 120. An opposing internal wall 122 of the airflow channel is also shown in FIG. 2. The opposing internal wall 122 at least partially forms part of the internal wall of the airflow channel 128 opposite to the second surface 104 of the heater unit 102. Further internal walls, that complete the definition of the airflow channel 128, connect the second surface 104 of the heater unit 102 and the opposing wall 122. For clarity, these further internal walls are not shown in the cut-away section in FIG. 2.

When a user draws on the mouthpiece 120, air is brought into the airflow channel 128 through air inlets (not shown) connected to the airflow channel 128 and located distal from the mouthpiece 120 so as to create a pressure change that draws the generated vapour flow to the mouthpiece 120, in the airflow 118 as it passes over the second surface 104, for inhalation by the user.

For clarity, sections of the body of the vapour generation device are not shown in FIG. 2, including portions containing control electronics, a power source such as a battery, and the electronics connecting the heater unit to the control electronics and power source.

Further details of the structure of the heater unit 102 will now be discussed.

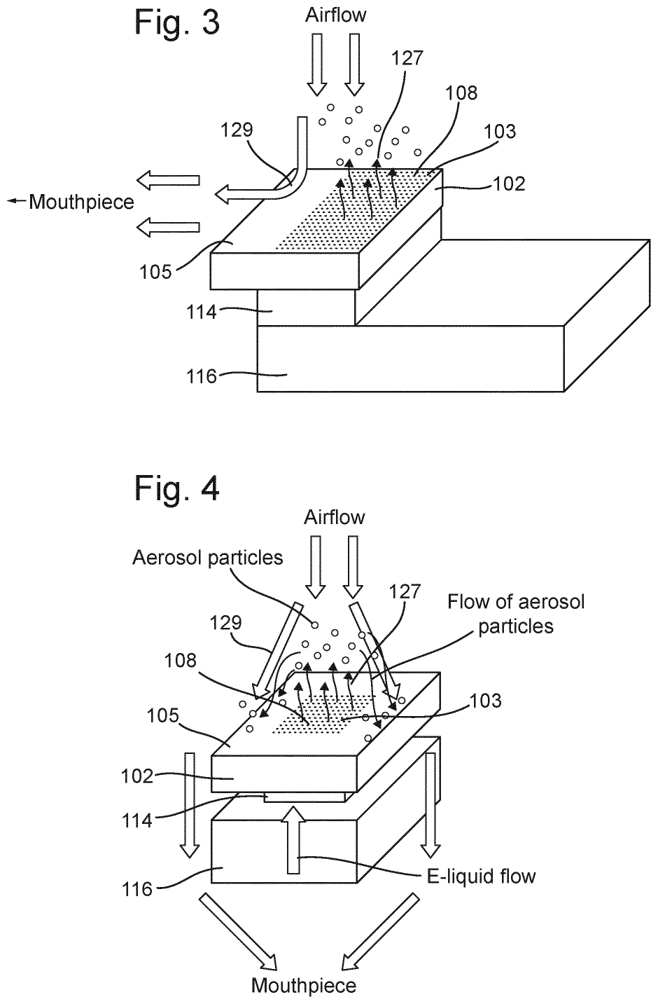

As previously mentioned, the heater unit 102 comprises a first heating portion 103 including the first and second surfaces 106, 104. As illustrated in FIG. 3, the heater unit 102 additionally comprises a second heating portion 105. The first heating portion 103 and second heating portion 105 are integrally formed such that together the first and second heating portions 103, 105 form a single heater unit 102.

As has already been explained, the first heating portion 103 is arranged to heat liquid received from the reservoir 116 of an electronic cigarette to generate a vapour. The second heating portion 105 is arranged to heat the vapour generated by the first heating portion 103.

As shown in FIG. 3, the second heating portion 105 does not comprise through-channels. In other words, the through-channels are only located within the first heating portion 103. This means that fluid, or vapour, is not able to pass through the second heating portion 105. The second heating portion 105 can be thought of as preventing fluid communication between the reservoir 116 and other components of the heater device 100, for example between the reservoir 116 the vapour flow path 128.

The second heating portion 105 has been shown to extend laterally alongside the first heating portion 103 in FIG. 3. However, in an alternative arrangement the second heating portion 105 is arranged peripherically around the first heating portion 103, as shown in FIG. 4. In this case the second heating portion 105 can be considered to substantially surround the first heating portion 103.

The first heating portion 103 provides a vaporising, or evaporating, function and so the first heating portion 103 can be thought of as an evaporator region with through-channels 108. The second heating portion 105 provides a reheating function, reheating the vapour generated by the first heating portion 103, and so the second heating portion 105 can be thought of as a reheater without through-channels. The heater unit 102 therefore comprises an evaporator region at least partially surrounded by a reheating region. Since the evaporator region 103 and the reheater 105 are integrated into a single heater unit 102, the overall number of components within the heater device 102 is reduced. This may help lower the energy consumption of the heater device 102.

As illustrated in FIGS. 3 and 4, the evaporation surface, which is the second surface 104 of the first heating portion 103, faces the distal end of the heater device, the distal end being opposite to the mouthpiece end. Generally, during use, aerosol particles that have been vaporised, or evaporated, by the evaporator region 103 are delivered to the reheating region 105 by the action of air flowing into the heater device 100 from the distal end of the heater device 100. The heater device therefore includes an airflow path that extends between the air inlets and the heater unit 102, allowing air to enter the heater device 100 and flow toward the heater unit 102.

The generated vapour is delivered to the second heating portion 105 from the first heating portion 103 under the action of air which has entered the air inlets and flowed along the airflow path. This is illustrated by the airflow arrows in FIGS. 3 and 4.

The vapour flow path 128 can be thought of as comprising a first vapour flow path 127 and a second vapour flow path 129. The vapour generated by the first heating portion 103 is arranged to flow away from the mouthpiece along the first vapour flow path 127, as shown in FIG. 3. The generated vapour is then arranged to flow towards the mouthpiece along the second vapour flow path 129. Thus the generated vapour is redirected, once it has left the evaporation surface, in order that the reheater 105 can reheat the generated vapour before it reaches the mouthpiece. The reheater 105 is therefore located within the second vapour flow path 129.

The first heating portion 103 will generally produce a relatively cold aerosol, or vapour, meaning that it is likely to condense on the walls of the vapour flow path 128 as it travels from the heater unit 102 to the mouthpiece. This can lead to an accumulation of liquid within the heater device 100 which can lead to leakage. This can be dangerous as it can lead to short circuits and malfunctioning of the heater device 100.

Instead, by providing a second heating zone, namely the reheating zone provided by the second heating portion 105, the aerosol can be additionally heated, increasing its temperature, which reduces the chance of the aerosol condensing on the internal walls of the vapour flow path 128 as it flows towards the mouthpiece. A further advantage of reheating the aerosol is that the droplet size can be more accurately controlled. In particular, reheating the aerosol reduces the size of the droplets, providing a smoother aerosol which has a more pleasant mouthfeel for the user.

If the optional wicking material 114 is included within the heater device 100, the wicking material 114 is arranged such that the wicking material 114 is arranged substantially next to the first surface 106 of the first heating portion 103. In particular, the wicking material 114 is located substantially next to the set of second openings 112 of the through-channels 108 in the first surface 106.

There is no wicking material 114 located substantially to a surface of the second heating portion 105. The wicking material 114 is removed from the reheater 105 in order to avoid vaporisation of liquid at the interface between the wick and the reheater 105 where there are no through-channels.

As the skilled person will appreciate, the heater device 100 described above, and any of its modifications, can be used as part of a capsule for an electronic cigarette. For example, the capsule includes a first end configured to engage with an electronic cigarette device and a second end arranged as a mouthpiece portion having a vapour outlet. The capsule also includes a reservoir arranged to store a liquid to be vaporised and the heater device described above.

The heater device 100 described above, and any of its modifications, can be also used as part of an electronic cigarette. For example, an electronic cigarette comprises a main body and a capsule. The main body has a power supply, electrical circuitry, and a capsule seating. The capsule seating of the main body is arranged to engage with and electrically connect with a first end of the capsule. A second end of the capsule is arranged as a mouthpiece portion having a vapour outlet. The capsule also includes a reservoir arranged to store a liquid to be vaporised and the heater device described above.

In some examples, the heater device 100 such as the heater device 100 of FIG. 1 includes the heater unit 102 and the reservoir 116, and optionally the wicking material 114, which can be formed as a single component. In some examples, the heater device 100 is a component of the vapour generation device, with the reservoir 116 being refillable. In some examples, the heater device 100 (including the heater unit 102, the reservoir 116, and optionally the wicking material 114) can be comprised in a removable capsule for the vapour generation device that can be detached from the vapour generation device (such as when the reservoir 116 is empty of liquid). In this example, the heater device 100 can be a replaceable consumable. Alternatively the reservoir 116 can be refilled. In other examples, the heater unit 102 can be a component of the vapour generation device, and the reservoir 116 (and optionally the wicking material 114) can form a removable component that can be detached from the vapour generation device (such as when the reservoir 116 is empty of liquid).

1. A heater device for an electronic cigarette comprising:
a heater unit arranged to vaporise a liquid received from a liquid reservoir to generate a vapour; and
a vapour flow path extending from the heater unit arranged to fluidly communicate with a mouthpiece of an electronic cigarette to allow the generated vapour to flow from the heater unit to the mouthpiece;
wherein the heater unit comprises a first heating portion and a second heating portion;
wherein the first and second heating portions are integrally formed such that the first and second heating portions form a single heater unit; and
wherein the first heating portion comprises a plurality of through-channels and the second heating portion does not comprise a plurality of through-channels.

2. The heater device according to claim 1 wherein the first heating portion is arranged to heat the liquid received from the liquid reservoir to generate the vapour.

3. The heater device according to claim 1 wherein the second heating portion is arranged to heat the vapour generated by the first heating portion.

4. The heater device according to claim 1 wherein the heater unit comprises a filter arranged to filter the generated vapour as it flows from the heater unit to the vapour flow path.

5. The heater device according to claim 4 wherein the filter comprises a plurality of through-channels passing through the heater unit.

6. The heater device according to claim 5 wherein all of the through-channels of the plurality of through-channels have substantially the same diameter.

7. The heater device according to claim 1 wherein the second heating portion is arranged to prevent fluid communication between the liquid reservoir and the vapour flow path.

8. The heater device according to claim 1 wherein the second heating portion extends laterally alongside the first heating portion.

9. The heater device according to claim 1 wherein the second heating portion is arranged peripherically around the first heating portion.

10. The heater device according to claim 1 wherein the vapour flow path comprises a first vapour flow path and a second vapour flow path, and wherein the generated vapour is arranged to flow away from the mouthpiece along the first vapour flow path and the generated vapour is arranged to flow towards the mouthpiece along the second vapour flow path.

11. The heater device according to claim 12 wherein the second heating portion is located within the second vapour flow path.

12. The heater device according to claim 1 further comprising an airflow path extending between an air inlet and the heater unit for allowing air to enter into the heater unit.

13. The heater device according to claim 12 wherein the generated vapour is delivered to the second heating portion from the first heating portion under the action of air which has entered the air inlet and flowed along the airflow path.

14. A capsule for an electronic cigarette, the capsule having a first end configured to engage with an electronic cigarette device and a second end arranged as a mouthpiece portion having a vapour outlet, the capsule further comprising:
a reservoir arranged to store a liquid to be vaporised;
a heater unit arranged to vaporise liquid received from the reservoir to generate a vapour; and
a vapour flow path extending between the heater unit and the mouthpiece to allow the generated vapour to flow from the heater unit to the mouthpiece;
wherein the heater unit comprises a first heating portion and a second heating portion;
wherein the first and second heating portions are integrally formed such that the first and second heating portions form a single heater unit; and
wherein the first heating portion comprises a plurality of through-channels and the second heating portion does not comprise a plurality of through-channels.

15. An electronic cigarette comprising a main body and a capsule wherein the main body comprises a power supply unit, electrical circuitry, and a capsule seating configured to connect with the capsule, the capsule comprising:
a first end configured to engage with the electronic cigarette device and a second end arranged as a mouthpiece portion having a vapour outlet, the capsule further comprising:
a reservoir arranged to store a liquid to be vaporised;
a heater unit arranged to vaporise liquid received from the reservoir to generate a vapour;
a vapour flow path extending between the heater unit and the mouthpiece to allow the generated vapour to flow from the heater unit to the mouthpiece;
wherein the heater unit comprises a first heating portion and a second heating portion;
wherein the first and second heating portions are integrally formed such that the first and second heating portions form a single heater unit; and
wherein the first heating portion comprises a plurality of through-channels and the second heating portion does not comprise a plurality of through-channels.
